(19) United States
(12) Patent Application Publication
(10) Pub. No.: US 2024/0363034 A1
(43) Pub. Date: Oct. 31, 2024

(54) ELECTRONIC LABEL SYSTEM AND METHOD

(71) Applicant: Triciti Coverage LLC, New York, NY (US)

(72) Inventors: Michael McMullen, Coto De Caza, CA (US); Matthew Gerson, New York, NY (US); David King, Sandy Hook, CT (US); John Hahn, Napa, CA (US)

(73) Assignee: Triciti Coverage LLC, New York, NY (US)

(21) Appl. No.: 18/748,742

(22) Filed: Jun. 20, 2024

Related U.S. Application Data
(60) Provisional application No. 63/522,909, filed on Jun. 23, 2023.

(51) Int. Cl. G09F 3/20; G08B 13/24

(52) U.S. Cl. CPC G09F 3/208; G08B 13/2462

(57) ABSTRACT

A system and method for providing an electronic label for an article, such as a manufactured product. The label includes a substrate adapted to affix to the article and a battery component provided on the substrate. An electronic circuit is provided on the substrate wherein the electronic circuit is provided with an identification number and a location determining component. A switch component is further provided that couples the electronic circuit and the battery component for energizing the electronic circuit, such that when energized, the electronic circuits is caused to transmit an electronic signal containing the circuit identification number and location information associated with the electronic label to a remotely located computer for performing analytics on the received data.

### CROSS-REFERENCE TO RELATED APPLICATIONS

This application claims priority to and the benefit of U.S. Provisional Application No. 63/522,909, filed Jun. 23, 2023, contents of which are herein incorporated by reference in their entirety.

### BACKGROUND

### Field

An electronic label, system and computer-implemented method for locating and identifying articles, such as manufactured products, and more particularly, for identifying a recipient of an article via user manipulation of an electronic label affixed to an article.

### Description of Related Art

The locating and identification of purchasers of products by the product manufacturer, which are sold through retail or distribution channels, are limited to those customers who make a conscious choice to fill out a “registration card”, scan a QR Code, or utilize text messaging, voice, or email. Product registration rates are typically between 2% and 20% depending on the value and type of product which is purchased.

Another known method relating to identifying a product has included the use of RFID technology. Data tag technology such as radio frequency identification (RFID) technology has employed passive smart tags (miniature antenna-containing tags requiring no internal power supply) that may be embedded in or attached to a product or material to convey information that may be read by a scanner or other interrogator device. Generally, conductive or passive smart tags include a data circuit and an antenna. In particular, smart tags include a semiconductor, a coiled, etched, or stamped antenna, a capacitor, and a substrate on which the components are mounted or embedded. A protective covering is typically used to encapsulate and seal the substrate. Other data mechanisms have been configured to be active or semi-passive.

In general, RFID systems and other data mechanism systems include readers and tags in which the tags generate an electromagnetic response to an electronic signal from a reader. The response signal is read by the reader, typically with a readable range on the order of a few feet, though broader or narrower ranges are possible. The signal generated by the tag includes information (e.g., an electronic product code) that identifies the tag or the product comprising the tag. While typical RFID systems, with handheld or fixed RFID readers, are advantageous in many circumstances, they have drawbacks. For instance, an ordinary consumer of goods typically does not have a RFID scanner, and even in the rare circumstances they do have access to one, they are often not inclined to use one to scan a product recently purchased for product registration purposes.

Yet another known method for identifying a product/article is using “smart labels”, which are generally labels affixed to a container and product shipping container. Such smart labels typically include circuitry for acquiring location information relating to the affixed container/package, and then establishing a connection to a communications network, for sending the acquired location information to a remotely located server for tracking the container/package. An example being disclosed in U.S. Pat. No. 11,599,850. While such smart labels have proven effective for tracking the shipment progress of a container/package, they are not effective for enabling, for example, warranty registration of a product since they were specifically configured for tracking shipment progress of a container/package, and as such, are wholly unconcerned with product registration, additional to other information deemed relevant after a product has concluded its shipment (e.g., it has been received by an end recipient/user). For instance, when a product is manufactured, the manufacturer often does not know who the consumer purchaser/user of the product is, but nonetheless has need for determining who an end recipient/user of the product is, such as, for providing product registration and/or warranty services.

Thus, there is a continued need for techniques and devices that can effectively and conveniently enable a product manufacturer to readily determine who an end recipient/user of a product is for conveying selective information regarding use/ownership of the product (e.g., a consumer product, such as an air conditioner, computers, washing machines, television, etc.).

### SUMMARY

The purpose and advantages of the below described illustrated embodiments will be set forth in and apparent from the description that follows. Additional advantages of the illustrated embodiments will be realized and attained by the devices, systems and methods particularly pointed out in the written description and claims hereof, as well as from the appended drawings.

To achieve these and other advantages and in accordance with the purpose of the illustrated embodiments, in one aspect, described is a system and method for providing an electronic label for an article, such as a manufactured product. The label includes a substrate adapted to affix to the article and a battery component provided on the substrate. An electronic circuit having an antenna component is provided on the substrate wherein the electronic circuit is preferably provided with an identification number and a location determining means (e.g., a Wi-Fi sniffing component and/or a GPS component). A switch component is further provided that couples the electronic circuit and the battery component for energizing the electronic circuit, such that when energized, the antenna component is caused to transmit an electronic signal containing the circuit identification number and geographic location information associated with the circuit as determined by the location determining component.

In a certain embodiment, the switch component preferably consists of a set of embedded traces provided on a bottom adhesive surface of a smart label, one or more of which will break when the user/purchaser removes the smart label from the product it is adhered to. Once a trace is broken, it causes an electronic circuit provided on the smart label to be energized causing, a component, such as a micro-processor, provided in the electronic circuit to capture data relevant to RF signals that are in proximity to the smart label. For instance, the RF signals may include (and are not to be understood to be limited to): GNSS signals, nearby radio sources, such as Wi-Fi and Bluetooth devices, and other signal sources, such as mobile cell towers. Such captured data is preferably stored in an on-board memory register of the electronic circuit. The smart label then preferably establishes wireless connection to one or more communication networks for transmitting the captured location data. And in accordance with certain embodiments, in the event that a network connection cannot be established, the electronic circuit of the smart label then preferably operates at reduced power until on-board sensors (e.g. shock sensor, accelerometer, etc.) detect that the smart label is in motion, at which time it will re-attempt to establish a network connection. It is noted that it may attempt to connect several times, until it is successful or no longer has sufficient power to transmit.

In other aspects, described is a process for locating and identifying an article using an electronic label configured to be affixed to the article. A unique ID is associated with the label, and product information associated with the article is likewise associated with the unique ID. Once a user/purchaser acquires the article, received in a remote server is a RF signal transmitted from the electronic label when the electronic label has been manipulated by a user in a predetermined way. The unique ID and location information indicating the location of the article when the label was manipulated is contained on the received RF signal. The remote server then determines 1) an address associated with location of the article, 2) identification of the article, and 3) identity of one or more users associated with the determined address, via analysis of the received RF signal, which in certain embodiments includes the use of Artificial Intelligence (AI) techniques.

In yet another aspect, described is an electronic label for affixation to an article including a substrate assembly adapted to removably affix to the article. The substrate assembly defines opposing planar top and bottom surfaces. The substrate assembly includes a battery component and an electronic circuit coupled to the battery component, wherein a unique identifier is preferably associated with the electronic circuit. The electronic circuit includes a memory and a processor disposed in communication with the memory. Further provided in the substrate assembly is a switch assembly having at least a portion provided on the bottom surface of the substrate assembly configured to couple the electronic circuit to the battery component for energizing the electronic circuit responsive to the substrate assembly being at least partially removed relative to the article. When the electronic circuit is energized, the processor upon execution of the instructions is configured to capture data associated with a location of the substrate assembly (location information) and transmit, via a communications network, the captured location data and the unique identifier, to a remotely located computer device. The remotely located computer device is preferably configured and operative to determine an address associated with the location information and identification information associated with the article. In certain embodiments the substrate assembly is defined by a plurality of layers, wherein the planar bottom surface of the substrate assembly defines the switch assembly. Preferably, at least a portion of the switch assembly is movable from first position to a second responsive to the substrate assembly being at least partially removed relative to the article, such that when at least a portion of the switch assembly is moved to the second position, the electronic circuit is caused to be energized. In certain embodiments, the switch assembly preferably includes a plurality of elongated switch components, and at least a portion of the planar bottom surface of the substrate assembly is provided with first adhesive material to removably affix the substrate assembly to the article, and at least a portion of each of the plurality of elongated switch components is provided with a second adhesive material to removably affix each of the plurality of elongated switch components to the article, whereby the second adhesive material provides a stronger adhesive bond than the first adhesive material whereby each of the plurality of elongated switch components is movable from the first position to the second position responsive to the substrate assembly being removed relative to the article.

In additional embodiments, the electronic label further includes a bottom substrate layer having opposing top and bottom surfaces, wherein the top surface of the bottom substrate layer is removably affixed to the bottom surface of the substrate assembly and the bottom surface of the bottom substrate layer is configured for affixation to the article, whereby when at least a portion of the bottom surface of the substrate assembly is removed from the top surface of the bottom substrate layer, the switch assembly couples the battery component to the electronic circuit affecting energization of the electronic circuit. At least a portion of the planar bottom surface of the substrate assembly is provided with first adhesive material to removably affix the substrate assembly to the top surface of the bottom substrate layer, and at least a portion of the switch assembly is provided with a second adhesive material to removably affix the switch assembly to the top surface of the bottom substrate layer, whereby the second adhesive material provides a stronger adhesive bond than the first adhesive material whereby at least a portion of the switch assembly is movable from the first position to the second position responsive to the substrate assembly being at least partially removed from the bottom substrate layer so as to cause energization of the electronic circuit. Additionally, the top surface of substrate assembly is provided with first indicia that is exposed to a user of the article, and wherein the top surface of the bottom substrate layer is provided with second indicia, such that when the substrate assembly is removed from the bottom substrate layer by the user, the second indicia is caused to be exposed to the user.

### BRIEF DESCRIPTION OF THE DRAWINGS

So that those skilled in the art to which the subject disclosure appertains will readily understand how to make and use the devices and methods of the subject disclosure without undue experimentation, preferred illustrated embodiments thereof will be described in detail herein below with reference to certain figures, wherein:

FIG. 1 illustrates an example communication network utilized with one or more of the illustrated embodiments;

FIG. 2 illustrates an example network device/node utilized with one or more of the illustrated embodiments;

FIG. 3 illustrates an exploded perspective view of an exemplary substrate assembly for an electronic smart label in accordance with the illustrated embodiments;

FIG. 4 illustrates a top view of a top substrate layer of the electronic smart label in accordance with the illustrated embodiments;

FIG. 5 illustrates a top view of a bottom substrate layer of the electronic smart label in accordance with the illustrated embodiments;

FIG. 6 illustrates a bottom view of a bottom substrate layer of the electronic smart label in accordance with the illustrated embodiments;

FIG. 7 illustrates a bottom view of a bottom substrate layer of the electronic smart label as it is being removed from an article it is removably affixed to in accordance with the illustrated embodiments;

FIG. 8 illustrates an exemplary process for use of the electronic smart labels in accordance with the illustrated embodiments;

FIG. 9A illustrates a diagram depicting an Artificial Intelligence (AI) device utilized with one or more of the illustrated embodiments;

FIG. 9B illustrates a diagram depicting an AI server utilized in accordance with one or more of the illustrated embodiments;

FIG. 10 illustrates a perspective view of an electronic smart label removably affixed to an exemplary article of manufacture in accordance with the illustrated embodiments; and

FIGS. 11A-11C illustrate various views of another illustrated embodiment of an electronic label having a two-part label configuration.

### DESCRIPTION OF CERTAIN EMBODIMENTS

The illustrated embodiments are now described more fully with reference to the accompanying drawings wherein like reference numerals identify similar structural/functional features. The illustrated embodiments are not limited in any way to what is illustrated as the illustrated embodiments described below are merely exemplary, which can be embodied in various forms, as appreciated by one skilled in the art. Therefore, it is to be understood that any structural and functional details disclosed herein are not to be interpreted as limiting, but merely as a basis for the claims and as a representation for teaching one skilled in the art to variously employ the discussed embodiments. Furthermore, the terms and phrases used herein are not intended to be limiting but rather to provide an understandable description of the illustrated embodiments.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the illustrated embodiments, exemplary methods and materials are now described.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

It is to be appreciated that the illustrated embodiments discussed below are preferably a software algorithm, program or code residing on computer useable medium having control logic for enabling execution on a machine having a computer processor. The machine typically includes memory storage configured to provide output from execution of the computer algorithm or program.

As used herein, the term “software” is meant to be synonymous with any code or program that can be in a processor of a host computer, regardless of whether the implementation is in hardware, firmware or as a software computer product available on a disc, a memory storage device, or for download from a remote machine. The embodiments described herein include such software to implement the equations, relationships and algorithms described above. One skilled in the art will appreciate further features and advantages of the illustrated embodiments based on the above-described embodiments. Accordingly, the illustrated embodiments are not to be limited by what has been particularly shown and described, except as indicated by the appended claims.

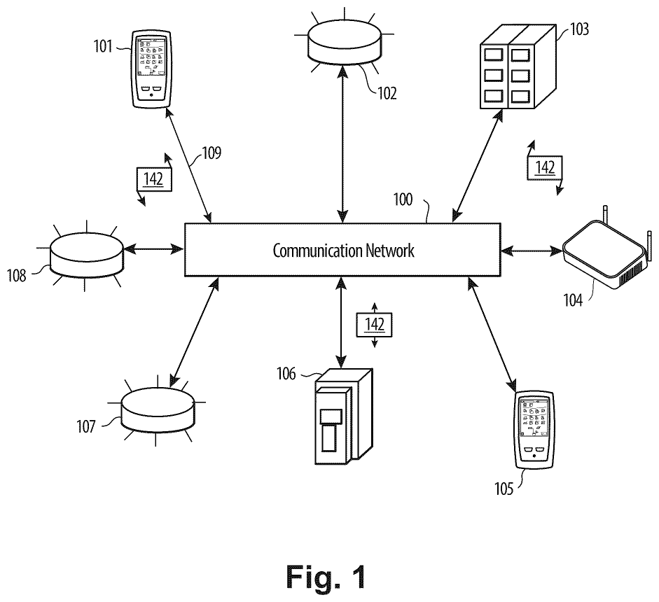

Turning now descriptively to the drawings, in which similar reference characters denote similar elements throughout the several views. FIG. 1 depicts an exemplary communications network 100 in which below illustrated embodiments may be implemented. It is to be understood a communication network 100 is a geographically distributed collection of nodes interconnected by communication links and segments for transporting data between end nodes, such as personal computers, workstations, smart phone devices, tablets, televisions, sensors and/or other devices such as automobiles, etc. Many types of networks are available, with the types ranging from local area networks (LANs) to wide area networks (WANs). LANs typically connect the nodes over dedicated private communications links located in the same general physical location, such as a building or campus. WANs, on the other hand, typically connect geographically dispersed nodes over long-distance communications links, such as common carrier telephone lines, optical lightpaths, synchronous optical networks (SONET), cellular communications (e.g., LTE-M), Low Power Wide Area Networking (LPWAN) (LoRaWAN), synchronous digital hierarchy (SDH) links, or Powerline Communications (PLC), and others.

FIG. 1 is a schematic block diagram of an example communication network 100 illustratively comprising nodes/devices 101-108 (e.g., sensors 102, client computing devices 103, smart phone devices 105, web servers 106, routers 107, switches 108, databases, and the like) interconnected by various methods of communication. For instance, the links 109 may be wired links or may comprise a wireless communication medium, where certain nodes are in communication with other nodes, e.g., based on distance, signal strength, current operational status, location, etc. Moreover, each of the devices can communicate data packets (or frames) 142 with other devices using predefined network communication protocols as will be appreciated by those skilled in the art, such as various wired protocols and wireless protocols etc., where appropriate. In this context, a protocol consists of a set of rules defining how the nodes interact with each other. Those skilled in the art will understand that any number of nodes, devices, links, etc. may be used in the computer network, and that the view shown herein is for simplicity. Also, while the embodiments are shown herein with reference to a general network cloud, the description herein is not so limited, and may be applied to networks that are hardwired.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random-access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store, a program for use by or in connection with an instruction execution system, apparatus, or device. A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the illustrated embodiments are described below with reference to flowchart illustrations and/or block diagrams of methods, apparatus (systems) and computer program products according to the illustrated embodiments. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

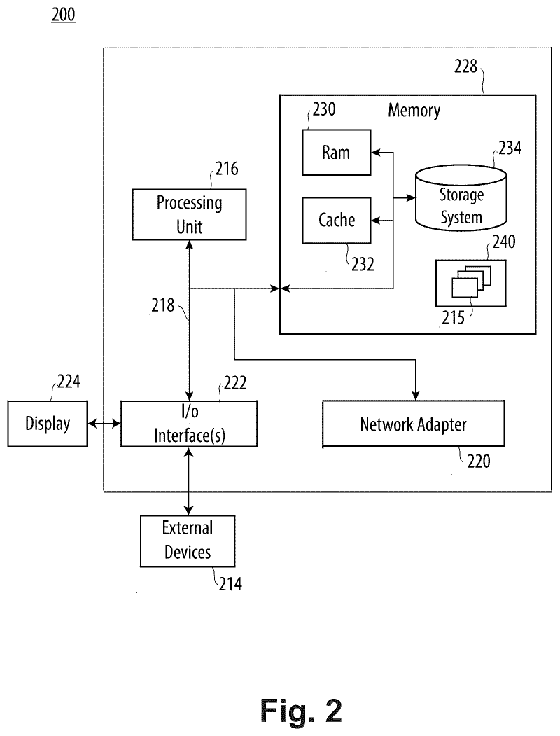

FIG. 2 is a schematic block diagram of an example network computing device 200 (e.g., client computing device 103, web server 106, etc.) that may be used (or components thereof that may be used) with one or more embodiments described herein, e.g., as one of the nodes shown in the network 100. As explained above, in different embodiments these various devices are configured to communicate with each other in any suitable way, such as, for example, via communication network 100.

Device 200 is intended to represent any type of computer system capable of carrying out the teachings of various illustrated embodiments. Device 200 is only one example of a suitable system and is not intended to suggest any limitation as to the scope of use or functionality of the illustrated embodiments described herein. Regardless, computing device 200 is capable of being implemented and/or performing any of the functionality set forth herein.

Computing device 200 is operational with numerous other general purpose or special purpose computing system environments or configurations. Examples of well-known computing systems, environments, and/or configurations that may be suitable for use with computing device 200 include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, and distributed data processing environments that include any of the above systems or devices, and the like. Computing device 200 may be described in the general context of computer system-executable instructions, such as program modules, being executed by a computer system. Generally, program modules may include routines, programs, objects, components, logic, data structures, and so on that perform particular tasks or implement particular abstract data types. Computing device 200 may be practiced in distributed data processing environments where tasks are performed by remote processing devices that are linked through a communications network. In a distributed data processing environment, program modules may be located in both local and remote computer system storage media including memory storage devices.

The components of device 200 may include, but are not limited to, one or more processors or processing units 216, a system memory 228, and a bus 218 that couples various system components including system memory 228 to processor 216. Bus 218 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus. Computing device 200 typically includes a variety of computer system readable media. Such media may be any available media that is accessible by device 200, and it includes both volatile and non-volatile media, removable and non-removable media.

System memory 228 can include computer system readable media in the form of volatile memory, such as random-access memory (RAM) 230 and/or cache memory 232. Computing device 200 may further include other removable/non-removable, volatile/non-volatile computer system storage media. By way of example only, storage system 234 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 218 by one or more data media interfaces. As will be further depicted and described below, memory 228 may include at least one program product having a set (e.g., at least one) of program modules that are configured to carry out the functions of embodiments of illustrated embodiments.

Program/utility 240, having a set (at least one) of program modules 215, such as underwriting module, may be stored in memory 228 by way of example, and not limitation, as well as an operating system, one or more application programs, other program modules, and program data. Each of the operating system, one or more application programs, other program modules, and program data or some combination thereof, may include an implementation of a networking environment. Program modules 215 generally carry out the functions and/or methodologies of the illustrated embodiments as described herein.

Device 200 may also communicate with one or more external devices 214 such as a keyboard, a pointing device, a display 224, etc.; one or more devices that enable a user to interact with computing device 200; and/or any devices (e.g., network card, modem, etc.) that enable computing device 200 to communicate with one or more other computing devices. Such communication can occur via Input/Output (I/O) interfaces 222. Still yet, device 200 can communicate with one or more networks such as a local area network (LAN), a general wide area network (WAN), and/or a public network (e.g., the Internet) via network adapter 220. As depicted, network adapter 220 communicates with the other components of computing device 200 via bus 218. It should be understood that although not shown, other hardware and/or software components could be used in conjunction with device 200. Examples, include, but are not limited to: microcode, device drivers, redundant processing units, external disk drive arrays, RAID systems, tape drives, and data archival storage systems, etc.

FIGS. 1 and 2 are intended to provide a brief, general description of an illustrative and/or suitable exemplary environment in which the below described illustrated embodiments may be implemented. FIGS. 1 and 2 are exemplary of a suitable environment and are not intended to suggest any limitation as to the structure, scope of use, or functionality of an illustrated embodiment. A particular environment should not be interpreted as having any dependency or requirement relating to any one or combination of components illustrated in an exemplary operating environment. For example, in certain instances, one or more elements of an environment may be deemed not necessary and omitted. In other instances, one or more other elements may be deemed necessary and added. For example, in certain instances, one or more elements of an environment may be deemed not necessary and omitted. In other instances, one or more other elements may be deemed necessary and added.

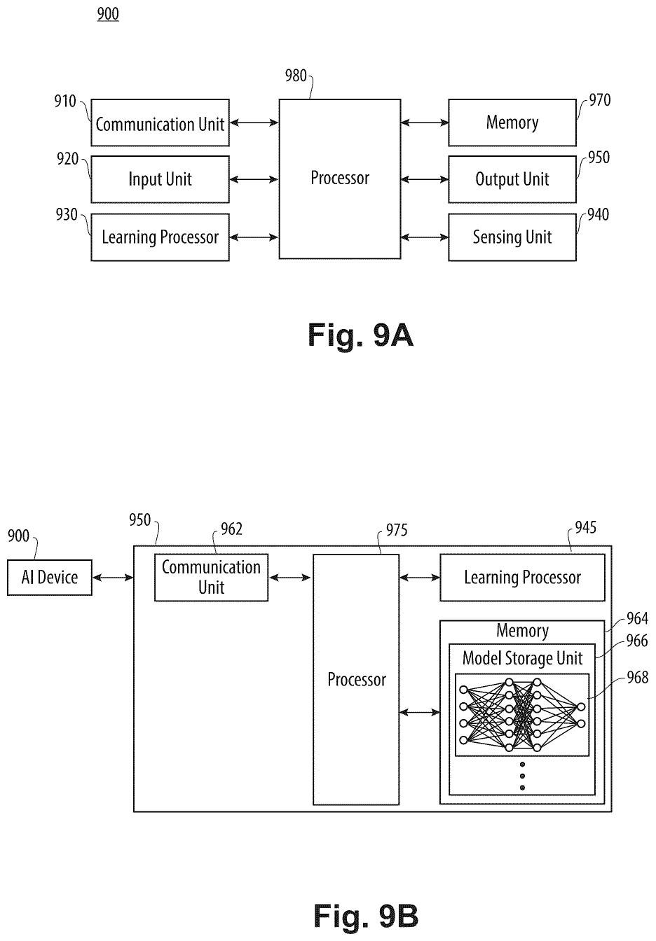

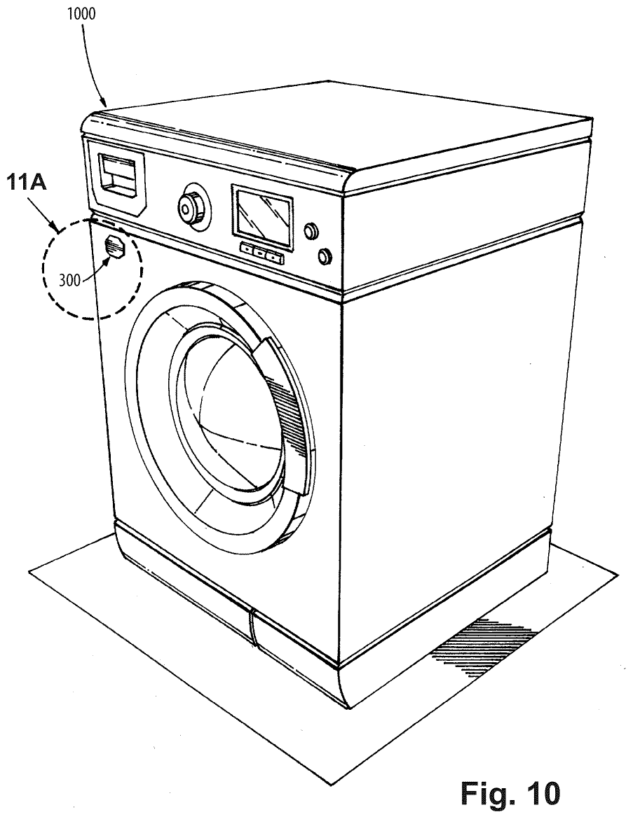

With the exemplary communication network 100 (FIG. 1) and computing device 200 (FIG. 2) being generally shown and discussed above, a description of certain illustrated embodiments will now be provided. It is to be understood and appreciated that exemplary embodiments implementing one or more components of FIGS. 1 and 2, and additionally later described FIGS. 9A and 9B, generally relate to an electronic label, system and method for locating and identifying articles, such as manufactured products, as well as the identity of a recipient of an article, and more particularly to locating, identifying and appending variables and propensity scores of products utilizing an electronic label provided with wireless network connectivity, including cellular, LoRaWAN, satellite or Wi-Fi communication protocols. In accordance with certain illustrated embodiments, described are electronic labels (300) which are preferably physically placed/affixed on a product or packaging (e.g., a washer machine 1000) by the product manufacturer or retailer, as shown for instance in FIG. 10.

The electronic label 300 is preferably scanned at the time of placement on the product 1000 (or prior to) to acquire information associated with the electronic label (e.g., a unique ID no.), as well as information (e.g., 404) associated with the product 1000 (e.g., the product's model and/or serial number). In certain embodiments, a master data file (e.g., a Master File) is created in a database containing this information so as to match the unique ID of the electronic label 300 with the product's 1000 model and/or serial number. As described herein, when the electronic label 300 is removed or otherwise caused to be “activated” (via activation of a switch component), preferably by a user/purchaser, the electronic label 300 is configured and operable to then automatically capture and transmit: 1) location information associated with the electronic label (e.g., RF/Wi-Fi signals, GPS location data, GNSS location data, GLONASS location data, Bluetooth information, data captured from eNodeB and/or Evolved Node B cellular base stations, etc.) (“location data”); and 2) it's unique ID no. (e.g., an IMEI no. or MAC address associated with an electronic circuit provided on the electronic label 300), preferably to a remotely located computer server (106) coupled (e.g., located in a cloud-site) to the aforementioned master data file. Upon reception of this transmitted information from the electronic label 300 in the computer server 106, preferably utilizing AI techniques (as described further below with reference to FIGS. 9A and 9B), address information associated with the received location data is determined (e.g., the RF/Wi-Fi signals are analyzed and preferably appended in databases which will result in address identification). Additionally, the computer server (106), preferably utilizing AI techniques, is further configured to determine the identity of a recipient of the article 1000 having the removably affixed electronic label 300, as well as numerous variable attributes associated with the recipient (as described further below), in addition to description of the article/product 1000 the label 300 was affixed to. In certain embodiments, a master data file is then preferably appended with variables and propensity scoring, preferably made via file transfer, webhook or API to the manufacturer or retailer, for marketing, sales or communications (e.g., product and/or warranty registration).

Further in accordance with the illustrated embodiments described herein, the electronic label 300 preferably is packaged as battery powered disposable communication device, which remains “dormant” until a switched connection is made caused by a user taking a certain action, such as manipulating the electronic label 300 in a predetermined manner (e.g., by removing/peeling the label, removing a tabbed portion or other mechanical activation, such as tearing a portion of the label), or pressing against a switched enabled portion of the label 300 (e.g., as identified by a “press here” identifier). As described in further detail below, such user action causes engagement of a connection of an electronic circuit with a battery so as to power a network communication component (e.g., a LoRaWAN transceiver, cellular transceiver, Bluetooth, satellite transceiver, and the like) preferably integrated with the electronic circuit provided on a substrate layer of the electronic label 300.

It is to be appreciated that in addition to identification of a product 100 the electronic label 300 is removably affixed to, and identification of an article's/product's user/purchaser/recipient, the electronic label 300 may have additional utility uses including (but not limited to) personal safety and emergency location for numerous articles (e.g., products, human beings, companion animals, etc.). Additionally, when the network communication device includes a LoRaWAN transceiver and/or satellite transceiver, the label 300, once activated, enables locating items in areas not readily available to cellular communications, both in land and sea.

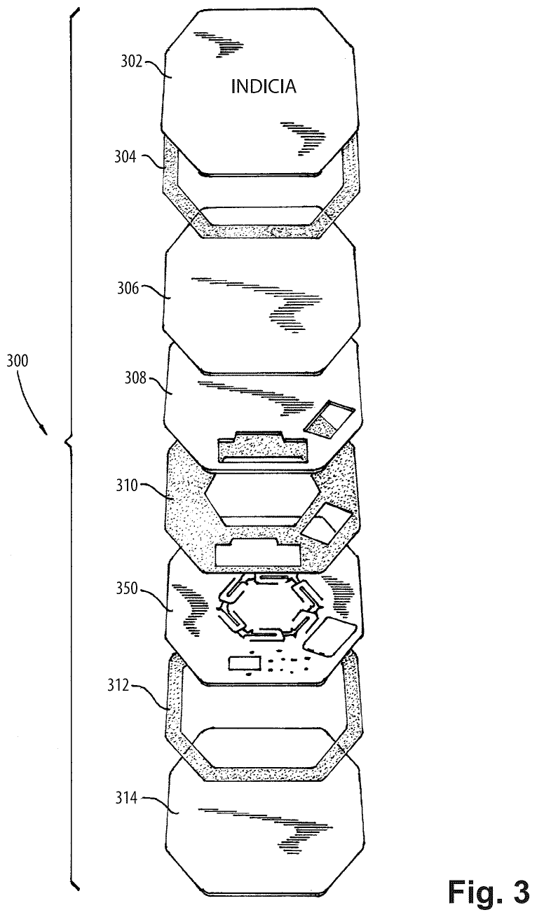

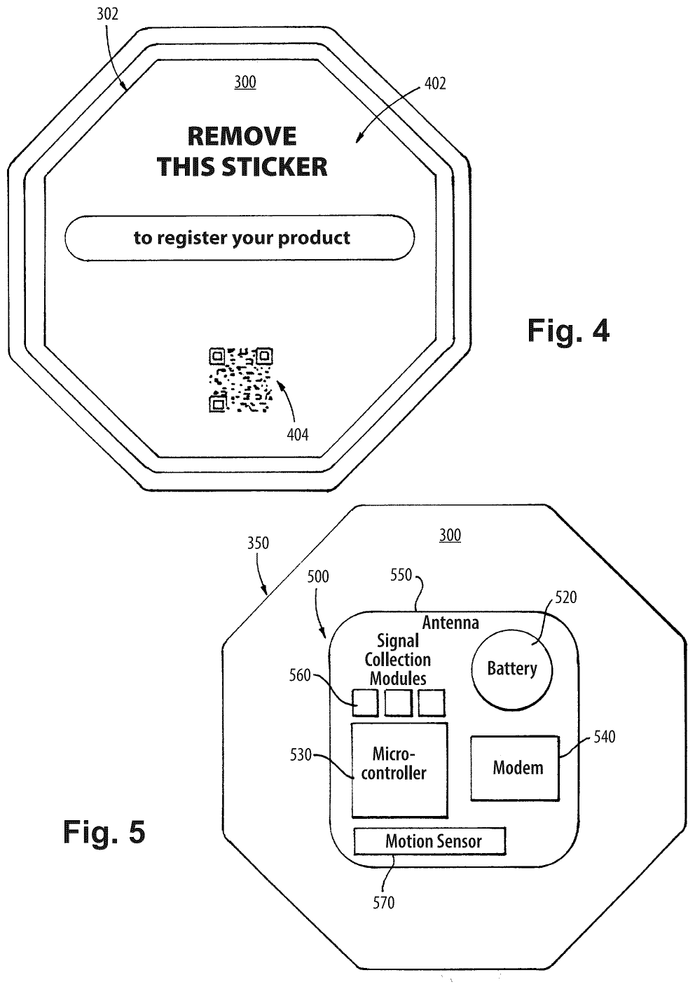

With reference now to FIG. 3, shown is an exemplary electronic label 300 constructed from a plurality of preferably flexible substrate layers 302-316. For instance, a topmost layer 302 (also shown in FIG. 4) includes printed indicia 402 (e.g., “REMOVE THIS STICKER to register your product”) as well as barcode item 404 that is preferably scanned at the time of affixing the label 300 to an article/product (e.g., a washer machine 1000-FIG. 10) (as described further below). Subsequent substrate layers may include: a thin film layer 304; an adhesive layer 306, a foam layer 308; another adhesive layer 310; a printed circuit board assembly and battery layer 350 (“circuit layer 350”); a differential tape layer 312; and a liner layer 314. It is to be understood and appreciated that the electronic label 300 shown in FIG. 3 is an exemplary illustrated embodiment of an electronic label 300 constructed and operable in accordance with the embodiments described herein. It is to be further understood and appreciated that the electronic label 300 may be constructed with various differing layer structures suitable for use in various different applications of the electronic label 300 in accordance with the preferred embodiments described herein. However, for ease of description purposes, and with reference to FIGS. 4-6, the electronic label 300 in accordance with the preferred embodiments is to be described hereinafter to consist of only a top layer substrate 302 and bottom layer substrate consisting of the circuit layer 350.

Generally, as described herein, the electronic label 300 is preferably constructed as a flexible substrate adapted to removably affix to an article 1000 (e.g., a product of manufacture). For illustrative purposes, FIG. 10 illustrates an electronic label 300 removably affixed to an article of manufacture 1000, shown for exemplary purposes as a washer machine appliance. It is to be understood and appreciated that the label 300 may be shaped and/or sized in any desirable shape/size, including (but not limited to): an octagon, a circle; triangle and a square (not shown). The label 300 is also to be understood to be dimensioned appropriately for affixation to an article 1000 it is intended to be affixed to (e.g., 4 cm×4 cm). It in accordance with the illustrated embodiments, the article 1000 may be one of a product of manufacture (e.g., a washer machine appliance or an air conditioner); an outer container or package for a product; or a living creature (e.g., a human being or a companion pet). For ease of description, the article 1000 is to be described herein as a product of manufacture (e.g., a washer machine appliance), however, the electronic label 300 in accordance with the illustrated embodiments is not to be understood to be limited to such a product of manufacture, as it may be affixed to a plurality of different types of articles, or living creatures.

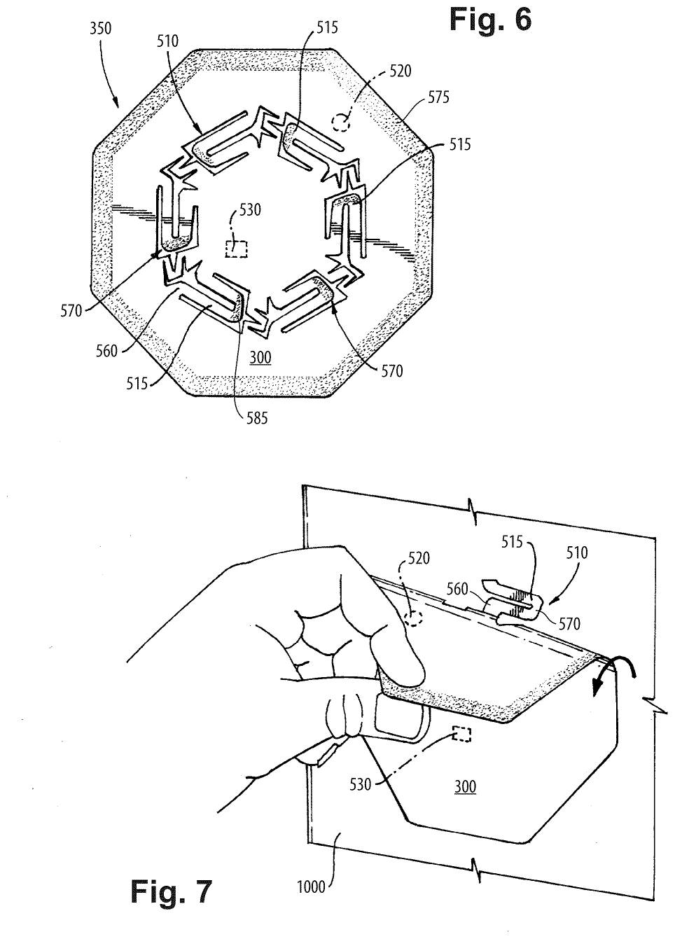

The electronic label 300 is preferably formed from substrate layers (302-314, 350-FIG. 3) adapted to affix to an article 1000. As mentioned above, for descriptive purposes of the illustrated embodiments, the label 300 preferably consists of top layer 302 (FIG. 4) and a bottom circuit layer 350 (FIGS. 5 and 6), which are preferably formed of flexible substrate materials. Starting with the top layer 302 of the label 300, its top (front) portion preferably includes indicia 402 associated with the article it is to be affixed to. For instance, and as shown in FIG. 4, the indicia 402 may include textual information regarding automated product registration for a washer machine appliance 1000 (e.g., “REMOVE THIS STICKER to register your device”), as well as other information, such as a barcode/skew/glyph 404 that is representative of the unique ID (e.g., a MAC address, an IMEI no., etc.) assigned to the circuit 500 associated with the electronic label 300, as described further below.

With reference now to FIGS. 5 and 6, in the illustrated embodiment shown, the electronic circuit 500 is disposed atop a switching component/assembly 510 provided on the bottom layer 350 of the label 300. The electronic circuit 500 may preferably be formed by a printed circuit board (PCB). The electronic circuit 500 is communicatively coupled to a battery 520 and micro-controller 530 provided in the electronic circuit 500 so as to energize the micro-controller 530 (e.g., connects the battery 520 to micro-controller 530) upon activation of the switch component/assembly 510 via user manipulation of the label 300 (e.g., peeling or removing of the label 300). In the present illustrated embodiment, and as discussed further below, the electronic circuit 500 preferably further includes a modem component 540, antenna component 550, a memory component 560 (which may consist of one or more signal collection modules), and in certain embodiments a motion sensor 570 (e.g., an accelerator, a shock sensor, and other sensors operable to detect motion/movement of the label 300) is also provided. The battery component 520 may be either a single use battery, such as a 300 mAh Li-Ion battery or alternatively, in certain embodiments, the battery 520 may be rechargeable enabling multiple uses. The battery 520 may be configured in multiple configurations suitable for an intended use, including as a thin filmed battery, or printed battery, deposited on the label substrate layer 350. The micro-controller 530 is preferably provided with a unique identification number (e.g., a MAC address, IMEI no., etc.), which is preferably indicated in the printed code 404 printed on the top layer 302 of the label 300, as mentioned above. In certain embodiments, the electronic circuit 500 is packaged in a Quad Flat No-Lead (QFN) package and is preferably dimensioned to have a nominal size relative to the label 300. It is to be understood, the electronic label 300 is not to be limited to what is shown and described herein, as it may be formed in various configurations suitable for a specific intended use and/or affixation to various components/articles. For instance, the electronic circuit 500 may include a cellular (e.g, LTE-M) or a satellite transceiver component for transmitting information from the electronic circuit 500, via a cellular or satellite communications network 100, to a remotely located computer device/system 106.

With primary reference now to FIG. 6, shown is a switch assembly 510 provided on the bottom circuit layer 350 of the label 300. The switch assembly 510, as mentioned above, is configured to couple the micro-controller 530 to the battery component 520 for energizing the micro-controller 530 responsive to the label 300 being removed, or partially removed, from an article 1000 it was removably affixed to. The switch assembly 510 is to be understood to be constructed of any suitable flexible electrically conductive material (such as, for example a printed circuit boards (PCB)).

In accordance with the illustrated embodiments, and as described further below, when energized, the micro-controller 530 upon execution of instructions stored in associated memory, is configured to capture data associated with a location of the label 300, such as (but not limited to) RF signals associated with Wi-Fi signals (“captured location information”) (and preferably indication of their signal strength as well) associated with nearby Wi-Fi access points. This captured location information is preferably stored in the one or more signal collection modules of the memory component 560 (as also further described below). When access to a communications network 100 is acquired by the micro-controller 530, the stored captured location data (and preferably the unique ID of the circuit 500) is transmitted, via the modem 540 and antenna 550 components, and via the communications network 100, to a remotely located computer server device 106 for determining an address associated with the electronic label 300 and identification information associated with the article 1000 it is removably affixed to. In accordance with the illustrated embodiments, the communication network 100 is preferably a long-range wide-area network (LoRaWAN), which is a wireless networking protocol that typically connects low battery-powered devices to the internet (provides bi-directional communication), which is currently recognized as an international standard for low power wide area networking.

It is to be understood and appreciated the illustrated embodiments are not to be understood to be limited to the aforesaid “captured location information” for consisting only of RF signals relating to nearby detected Wi-Fi signals, nor using a LoRaWAN network as the communication network 100 for the transmitting the captured location data. Alternatively, other components/methods for acquiring such “captured location information” may be utilized (e.g., capturing cell tower information, GPS coordinates, etc.). Additionally, other communication networks, additional to a LoRaWAN network, may be utilized for transmitting the captured location data, including for instance (but not limited to) Bluetooth, Bluetooth Low Energy (BLE), cellular (LTE, 5G, NB, etc.), Narrow Band Cellular (NB-Iot), satellite, LPWAN, and other suitable communication networks. For instance, the electronic circuit 500 may include either a GNSS or GPS receiver component for determining geospatial location coordinates associated with a current location of a label 300. Additionally, the electronic circuit 500 may provide wireless network connectivity programmable to support a plurality of wireless standards including (but not limited to) Wi-Fi b/g/n, BluetoothLE, IPv4/IPv6 with TCP/UDP, FTP, HTTTP, TLS, HTTPS, SSL, MQTT. For example, the electronic circuit 500 may provide cellular connectivity, via an integrated cellular transceiver, preferably being programmable to support a plurality of wireless cellular standards including (but not limited to) LTE-NB2, LTE 3GPP, and CAT-NB2, and wherein a unique ID associated with the electronic label 500 is an International Mobile Equipment Identity (IMEI) number. Alternatively, in other embodiments, the electronic circuit 500 is configured to provide satellite connectivity, which is preferably programmable to support a plurality of wireless standards including (but not limited to) n255 and n256. And in other embodiments, the electronic circuit 500 is configured and operative to provide both wireless network connectivity and satellite connectivity.

It is to be additionally understood that the electronic label 300 may include additional components provided in its circuit 500 including (but not limited to) one or more sensor components. For instance, such sensor components may be configured and operative to detect temperature, humidity, vibration and/or shock values associated with the article 1000 the label 300 is removably affixed to. In additional embodiments, such sensor components are configured and operative to detect vibration (e.g., movement) of the actual label 300 itself, during and/or after it is removed from the article 1000 it is removably affixed to.

With regard now to the switch assembly 510, it is to be understood and appreciated that in certain illustrated embodiments, at least a portion of a substrate layer (e.g., 350) of the label 300 forms at least a portion of the switch assembly 510, such that when the label 300 is manipulated in a predetermined manner by a user of the article 1000 the label 300 is removably affixed to, the electronic circuit 500 is caused to be energized. For instance, a portion of the circuit substrate layer 350 of the label 300 is peelable, removable, or tearable (causing movement of the switch assembly 510) by a user so as to cause the micro-controller 530 of the electronic circuit 500 to be energized. Thus, the micro-controller 530 remains non-energized until a switched connection is made via the aforesaid user manipulation of a switch assembly/component 510 provided on the label 300. As shown in FIG. 6, a planar bottom surface portion of the substrate layer 350 defines the switch assembly 510, wherein at least a portion of the switch assembly 510 is movable from first position to a second responsive to the bottom substrate layer 350 being removed from the article 1000, such that when the at least a portion of the switch assembly 510 is moved to the second position, the micro-controller 530 of the electronic circuit 500 is caused to be energized.

With continued reference to FIG. 6, a back portion of the substrate layer 350 preferably includes a pressure sensitive adhesive for removably affixing the substrate layer 350 (and hence the label 300) to an article 1000. In accordance with the illustrated embodiments, the switch assembly 510 preferably includes a plurality of elongated switch components 515, as shown in FIG. 6. Each switch component 515 preferably includes a base portion 560 and a curved elongated flexible tail portion 570 extending from the base portion 560, as shown in FIG. 6.

It is to be appreciated and understood that description of the switch assembly 510 for activating the micro-controller 530 upon removal of the label 300 illustrated in FIG. 6 having a plurality (e.g., six (6)) switch components 515 arranged in a circular configuration relative the label substrate layer 350 they are provided on is only any exemplary embodiment of such a switch assembly 510 and is not to be understood to be limited to what is shown in FIG. 6. It is to be understood and appreciated the switch assembly 510 may be constructed/formed with a differing number of switch components 510, and/or in differing configurations, while still retaining operability to energize the electronic circuit 500 upon the label's 300 removal from an article 1000 it was removably affixed to.

With regard to removably affixing the label 300 to a portion of an article 1000, and with reference to FIGS. 6 and 7, preferably, at least a portion of the planar bottom surface of the substrate layer 350 is provided with first adhesive material 575 to removably affix the label 300 to an article 1000, and at least a portion of each of the plurality of elongated flexible tail portion 570 of each switch component 515 is provided with a second adhesive material 585 to removably affix each of the plurality of elongated switch components 515 to the article 1000, whereby the second adhesive material 585 provides a stronger adhesive bond than the first adhesive material 575. Thus, with regard now to removing (e.g., peeling) a label 300 from an article 1000, and with primary reference now to FIG. 7, when the label 300, or at least a portion of the label 300 containing at least one switch component 510, is caused to be removed from the article 1000 it was removably affixed to, due to the difference in strength of the aforementioned first 575 and second 585 adhesive materials, the portion of the substrate have the weaker first adhesive material 575 is first caused to separate from the article 1000 causing the at least one switch component 510 having the stronger second adhesive material 585 to remain affixed to the article 1000. Thus, the flexible tail portion 570 of the at least one switch component 510 remains, for at least a period of time, in contact with the article 1000, while a remaining portion of the label 300 has been separated from the article 1000, consequently causing the flexible tail portion 570 of the at least one switch component 510 to flex/move to a second position (relative to a first position when the entire label 300 remained affixed to the article), as shown in FIG. 7. It is to then be understood that when at least one switch component 510 is flexed/moved to the aforesaid second position during removal of a label 300, it provides an electrical coupling 590 between the battery component 520 and the micro-controller 530 operably to activate/energize the micro-controller 530 to enable its functionality described herein.

In use, and as described in further detail below, when the electronic circuit 300 is energized (e.g., affected by peeling and/or tearing of the label 300 (e.g., to register an article/product 1000 the label 300 is affixed to)), an electronic signal containing the aforesaid unique ID and captured location data is transmitted from the micro-controller 530, preferably via modem 540 and antenna 550 components 525, via preferably a LoRaWAN communication network 100, so as to be received by a remotely located server computer/system 106/706. The remotely located server 106 is preferably configured to determine an address associated with location of the article 1000/label 300, via analysis of the received captured location data, so as to then determine identity of one or more users/purchasers of the article 1000 preferably associated with the determined address. The server 106 is further preferably configured to determine an identity and/or description of the article/product 1000, via analysis of the unique ID associated with the electronic circuit 500 (as described further below). Additionally, in certain embodiments, the remotely located computer server 106 is further configured to determine one or more variables associated with the determined one or more users/purchasers, including propensity to purchase warranty coverage and/or propensity to purchase other products and services. As described further below, in certain illustrated embodiments, the computer/server 106 preferably utilizes one or more AI techniques during its analysis and determination processes, as mentioned further below with reference to AI processor 980 (FIG. 9A) and AI server 950 (FIG. 9B).

In accordance with the illustrated embodiment, in use (when activated via the switch assembly 510 as described above) the electronic label 300, via the micro-controller 530 of electronic circuit 500, captures data associated with the real-time location of the label 300 (and the article 1000 it is affixed to), preferably via antenna 550, which includes, in certain embodiments, capturing Wi-Fi information, and in some embodiments, measurement of the signal strength of the captured Wi-Fi information, preferably relating to a plurality of access points located in proximity to the label 300, as detected by the micro-controller 530 of the electronic circuit (hereinafter referred to as the “captured location data”). This captured location data is then preferably stored in the memory 560 (e.g., signal collection modules). Once captured, this location data (e.g., Wi-Fi RF signal data/information regarding Wi-Fi access points detected by the micro-controller 530), preferably along with the unique ID assigned to the electronic circuit 500, is retrieved from the memory 560 so as to be transmitted (via the modem and antenna components 540 and 550), preferably via a detected LoRaWAN communications network 100, to the remotely located computer/server 106, for subsequent computer analysis, as described herein. For instance, the aforesaid captured location data may consist of using Wi-Fi sniffing techniques to capture RF signal data packets associated with each of a plurality of Wi-Fi access points located in proximity to the label 300, along with signal strength measurement information associated with a captured access point information. Additionally, the transmitted captured location data sent from the micro-controller 530 further preferably includes, in accordance with the illustrated embodiments, the assigned unique ID of the electronic circuit 500 of a label 300 (e.g., a MAC address associated with the micro-controller 530).

In accordance with certain embodiments, it is to be appreciated that typically a threshold amount of captured access data is required by the computer/server 106 to enable proper and accurate analytics for making its determinations (e.g., address determination and user identification). For instance, captured location data relating to at least eight (8) different access points may be required by the computer/server 106, thus the micro-controller 530 in certain embodiments will not transmit it's captured location data until it has received location data from at least a predetermined number of access points (e.g., least eight (8) different access points). Thus, to conserve battery energy, in certain embodiments, the micro-controller 530 is configured and operable to determine if a predetermined threshold amount of Wi-Fi information associated with respective access points (e.g., eight (8)) have been captured and stored in memory 560, whereby if yes, then the captured location data, and the unique ID, is then caused to be transmitted to the remotely located computer/server 106. And if no, (the micro-controller 530 determines a predetermined threshold amount of Wi-Fi information associated with respective access points (e.g., eight (8) have not been captured and stored in memory 560), then the micro-controller 530 is further configured to initiate a timer for placing the electronic circuit 500 in a sleep mode until expiration of the timer (e.g., 5 minutes), after which the electronic circuit 500 is re-energized causing the micro-controller 530 to re-attempt to capture additional location data, and thereafter repeat the above functionality regarding determining if a threshold amount of location data has been captured and stored in memory 560.

In certain other embodiments, alternative to using the aforesaid timer, the electronic circuit 500 includes a motion sensor 570 wherein if it is determined a predetermined threshold amount of location data has not been captured (as discussed above), then the micro-controller 530 is further configured and operative for placing the electronic circuit 500 in a sleep mode until the movement sensor 570 detects the label 300 has moved, after which the electronic circuit 500 is re-energized causing the micro-controller 530 to attempt to capture additional location data, and thereafter repeat the above functionality regarding determining if a threshold amount of location data has been captured and stored in the memory. It is to be appreciated and understood that the movement sensor 570 may be operative and configured to also detect shock or other determining factors for changing the state of operation for the electronic circuit 500.

Once the location data has been captured by the micro-controller 530 (and preferably stored in memory 560), the micro-controller 530 is then further configured and operable to determine if preferably a suitable communications network 100 (e.g., a LoRaWAN network) is accessible for transmitting the captured location data stored in memory 560, and the unique identifier associated with the electronic circuit 500 of the label 300, to the remotely located computer/server 106. If yes, the captured location data stored in memory 560, and the unique identifier associated with the electronic circuit 500 of the label 300 is transmitted, via a suitable communications network 100, to the remotely located computer/server 106. And if no, to preferably conserve battery energy 520, then the micro-controller 530 is further configured and operable to initiate a timer for placing the electronic circuit 500 in a sleep mode until expiration of the timer (e.g., 5 mins), after which the electronic circuit 500 is re-energized causing the micro-controller 530 to again seek access to such a suitable communications network 100 (e.g., a LoRaWAN network) for transmitting the captured location data, and the unique identifier, to the remotely located computer/server 106.

It is to be appreciated that the aforesaid signal is to be transmitted from the electronic label 300 to a gateway device associated with communication protocol of the communications network (e.g., a LoRaWAN network) utilized for transmitting the information from the electronic circuit 500. The signal transmitted from the electronic circuit 500 of the label 300 preferably includes an IP address of the remotely located computer/server 106 enabling routing of the transmitted information from the gateway device to the intended remotely located computer/server 106 associated with the aforesaid IP address.

In certain other embodiments, alternative to using the aforesaid timer, the electronic circuit 500 includes a motion sensor 570 wherein if it is determined a suitable communications 100 (e.g., a LoRaWan) is not available/accessible to the electronic circuit 500 (as discussed above), then the micro-controller 530 is further configured and operative for placing the electronic circuit 500 in a sleep mode until the movement sensor 570 detects the label 300 has moved a predetermined distance (which may be premised upon a time delay), after which the electronic circuit 500 is re-energized causing the micro-controller 530 to again seek access to an accessible suitable communications network 100 for transmitting the captured location data stored in memory 560, and the unique identifier associated with the electronic circuit 500 of the label 300, to the remotely located computer/server 106.

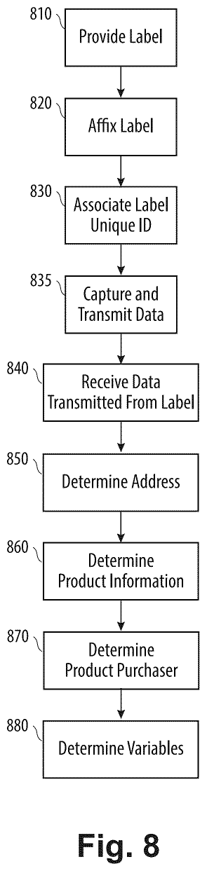

With reference now to FIG. 8 (and with continuing reference to FIGS. 1-7), described now is a generalized process 800 regarding usage of an electronic label 300 in accordance with the illustrated embodiments. Starting at step 810, an electronic label 300 (as described above) is preferably provided from a label manufacturer/provider. Next, at step 820, this label 300 is then affixed to an article/product 1000 to be distributed/sold (as described above), such as by a product manufacturer. The article(s)/product(s) 1000 is then preferably supplied to a product distributor for sale/distribution to product purchasers/users. It is to be appreciated that in certain embodiments, alternative to the product manufacturer, the label 300 may be affixed to the product by a distributor, product retailer or other interested entity. Next, at step 830, the unique ID (e.g., a MAC address, IMEI no., etc.) associated with the electronic circuit 500 of the label 300, which is preferably indicated on a barcode 404 printed on the label 300 (FIG. 4), is then associated with the product 1000 (e.g., the product's skew or barcode), preferably by a suitable scanning device utilized by the product manufacturer and/or distributor. In accordance with the illustrated embodiments, this information is preferably included in a master data file, preferably in a computer server 106 which may be maintained by the label manufacturer/provider or another suitable interested party.

After the labelled product/article 1000 is purchased, or otherwise supplied/provided to a user/purchaser, the user/purchaser preferably manipulates the electronic label 300 affixed to the product 1000 (as described above) (e.g., for an intended purpose, such as product registration) to cause the electronic circuit 500 provided on the label 300 to be energized by its battery source 520, preferably triggered by the switching assembly 510 provided on the label 300, as described above. At step 835, the micro-controller 530, once energized, is caused to capture the location data (as also described above) responsive to a portion, or the entirety of the electronic label 300 being separated from the article 1000 it was removably affixed to. Once the location data has been captured, the micro-controller 530 is then operable to transmit the captured location data, preferably along with its aforesaid unique ID, to the remotely located computer server 106.

As mentioned above, in certain embodiments, the micro-controller 530 is further configured and operable to determine if a predetermined threshold amount of location data (e.g., Wi-Fi information associated with respective access points) have been captured, whereby if yes, then the captured location data is caused to be transmitted to the remotely located computer server 106. And if no, then the micro-controller 530 is configured and operable to initiate a timer for placing the electronic circuit 500 provided on the electronic label 300 in a sleep mode until expiration of the timer, after which the electronic circuit 500 is re-energized causing the micro-controller 530 to capture additional location information, so as to then preferably repeat the above process for determining if a threshold amount of location data has been captured by the electronic circuit 500 of the electronic label 300.

It is to be understood and appreciated the illustrated embodiments are not to be understood to use a timer device for enabling the label 300 to transition to a sleep mode and then re-energize to either re-attempt to capture location data and/or establish a wireless connection to a communication network 100, as the electronic label 300 in accordance with the illustrated embodiments may rely on other components types, such as for example, a movement sensor for accomplishing the aforesaid sleep/re-energize functionality for the electronic circuit 500 of the electronic label 300.

With regard to transmitting the captured location data from the electronic label 300, in certain embodiments the micro-controller 530 is configured and operable to determine if a suitable communications network 100 (e.g., a LoRaWAN network) is accessible to the electronic label 300 for transmitting the captured location data, and it's unique ID, to the remotely located computer server 106. If no, then the micro-controller 530 is preferably configured and operative to initiate a timer for placing the electronic circuit 500 provided on the electronic label 300 in a sleep mode until expiration of the timer, after which the electronic circuit 500 is re-energized causing it to again seek access to a suitable communications network 100 for transmitting the captured location data along with its unique ID. Once a suitable communications network 100 is accessible by the electronic circuit 500, the electronic circuit 500 transmits the captured location data and its unique ID so as to be received within an intended remotely located computer server 106, step 840.

Upon receiving the aforesaid captured location data and unique ID transmitted by an “activated” label 300, preferably via a gateway component, the computer server 106 (which may be associated with a provider of the label 300) preferably determines an address associated with the received location data of the label 300, via analysis of the received location data (e.g., RF signals and respective signal strengths relating to Wi-Fi access points), step 850. Next, at step 860, the computer server 106 preferably determines identification of the article/product 1000 (e.g., a certain model of a washing machine appliance) by making reference to the aforesaid master data file using the received unique ID of the activated label (e.g., the master data file matches the label's unique ID (e.g., a MAC address) to a product description (step 830)). Next, at step 870, the computer server 106 preferably determines an identity of the purchaser/user of the article/product, via analysis of the determined address associated with the current location of the label 300 (step 850). Preferably, the aforesaid master data file is then appended to include the determined address (step 850); the determined product information (step 860); and the determined purchaser/user (step 870).

It is to be appreciated the determination of this information is advantageous in a number of ways, including (but not limited to) effectuating registration of the product/article 1000 by merely having a user activate (e.g., remove) a label 300 on a newly purchased product 1000, which is a significant technology improvement over prior methods for effectuating product registration. For instance, registration can automatically be made by a computer server (e.g., 106) since both the identity of the purchaser and purchased product was determined, as described above. This information is also useful for providing future value-added services to the purchaser, such as providing a supply of consumables for the product, replacement parts and other relevant ancillary services and/or products/components. In this regard, the computer server 106, in certain illustrated embodiments is further configured and operable to determine one or more variables associated with the determined users, which are likewise then preferably appended into the master data file. For instance, such variables (which may be determined using predictive analytic techniques) may indicate a purchaser's propensity regarding future actions, such as (but not limited to): purchasing warranties, purchasing other products and/or services, being responsive to certain marketing campaigns, travel and/or entertainment habits, vehicle purchasing behavior, and the like. Determining this purchaser information is particularly useful in determining the justification/probability of success for certain future marketing and/or offerings directed to the purchaser.

Thus, since product manufacturers often communicate with, market to, and sell products and services to those known customers which have been identified as owning their products, advantages of the described illustrated embodiments provides a significant increase in the identification of product owners, appending data attributes, propensity scoring, which significantly increases the addressable market of product owners to increase offerings of value added services.

As mentioned above, in certain illustrated embodiments, the computer server 106 preferably utilizes one or more AI techniques during its analysis and determination processes (e.g., steps 840-850). In this regard, in certain illustrated embodiments (e.g., the remotely located computer server 106) is provided with self-learning/Artificial Intelligence (AI) for determining certain user/purchaser information, such as (but not limited to): an address associated with a recently purchased article, determining one or more users associated with the identified address, and determining one or more variables associated with the determined one or more users, including the propensity to purchase warranty coverage and/or propensity to purchase other products and services. Preferably a web server receives data, via a wireless communication network, from a label affixed to a product, consisting of information associated with the newly purchased product and location information associated with the newly purchased product, whereby the computer server 106 is preferably coupled to a plurality of external databases/data sources enabling an AI system to implement machine learning and artificial intelligence algorithms to conduct one or more of the above mentioned determinations. For instance, the AI system may include two subsystems: a first subsystem that learns from historical data; and a second subsystem to identify and recommend one or more parameters or approaches based on the learning. It should be appreciated that although the AI system may be described as two distinct subsystems, the AI system can also be implemented as a single system incorporating the functions and features described with respect to both subsystems.

In accordance with the illustrated embodiments described herein, AI or artificial intelligence refers to the field of studying artificial intelligence or methodology for making artificial intelligence, and machine learning refers to the field of defining various issues dealt with in the field of artificial intelligence and studying methodology for solving the various issues. Machine learning is defined as an algorithm that enhances the performance of a certain task through a steady experience with the certain task.

Also in accordance with the illustrated embodiments, an artificial neural network (ANN) is a model used in machine learning and may mean a whole model of problem-solving ability which is composed of artificial neurons (nodes) that form a network by synaptic connections. The artificial neural network can be defined by a connection pattern between neurons in different layers, a learning process for updating model parameters, and an activation function for generating an output value. The artificial neural network may include an input layer, an output layer, and optionally one or more hidden layers. Each layer includes one or more neurons, and the artificial neural network may include a synapse that links neurons to neurons. In the artificial neural network, each neuron may output the function value of the activation function for input signals, weights, and deflections input through the synapse.

Model parameters refer to parameters determined through learning and include a weight value of synaptic connection and deflection of neurons. A hyperparameter means a parameter to be set in the machine learning algorithm before learning, and includes a learning rate, a repetition number, a mini batch size, and an initialization function. The purpose of the learning of the artificial neural network may be to determine the model parameters that minimize a loss function. The loss function may be used as an index to determine optimal model parameters in the learning process of the artificial neural network. Machine learning may be classified into supervised learning, unsupervised learning, and reinforcement learning according to a learning method. The supervised learning may refer to a method of learning an artificial neural network in a state in which a label for learning data is given, and the label may mean the correct answer (or result value) that the artificial neural network must infer when the learning data is input to the artificial neural network. The unsupervised learning may refer to a method of learning an artificial neural network in a state in which a label for learning data is not given. The reinforcement learning may refer to a learning method in which an agent defined in a certain environment learns to select a behavior or a behavior sequence that maximizes cumulative compensation in each state.

Machine learning, which is implemented as a deep neural network (DNN) including a plurality of hidden layers among artificial neural networks, is also referred to as deep learning, and deep learning is part of machine learning.

With reference now to FIG. 9A, illustrated is an AI device 900 according to an illustrated embodiment. In conjunction with FIGS. 1 and 2, the AI device 900 is operatively coupled to, or integrated with computing device 106, in accordance with the illustrated embodiments described herein. AI device 900 preferably includes a communication unit 910, an input unit 920, a learning processor 930, a sensing unit 940, an output unit 950, a memory 970, and a processor 980. The communication unit 910 may transmit and receive data to and from external devices such as other AI devices 900a to 900e and the AI server 950 (FIG. 9B) by using wire/wireless communication technology. For example, the communication unit 910 may transmit and receive sensor information, a user input, a learning model, and a control signal to and from external devices.

The communication technology used by the communication unit 910 preferably includes GSM (Global System for Mobile communication), CDMA (Code Division Multi Access), LTE (Long Term Evolution), 5G, WLAN (Wireless LAN), Wi-Fi (Wireless-Fidelity), Bluetooth™, RFID (Radio Frequency Identification), Infrared Data Association (IrDA), ZigBee, NFC (Near Field Communication), and the like.

The input unit 920 may acquire various kinds of data, including, but not limited to information associated with the newly purchased product (e.g., to identify the product) and location information associated with the newly purchased product. The input unit 920 may acquire a learning data for model learning and an input data to be used when an output is acquired by using learning model. The input unit 920 may acquire raw input data. In this case, the processor 980 or the learning processor 930 may extract an input feature by preprocessing the input data. The learning processor 930 may learn a model composed of an artificial neural network by using learning data. The learned artificial neural network may be referred to as a learning model. The learning model may be used to infer a result value for new input data rather than learning data, and the inferred value may be used as a basis for determination to perform a certain operation.

The learning processor 930 may perform AI processing together with the learning processor 930 of the AI server 950, and the learning processor 930 may include a memory integrated or implemented in the AI device 900. Alternatively, the learning processor 930 may be implemented by using the memory 970, an external memory directly connected to the AI device 900, or a memory held in an external device.

The output unit 950 preferably includes a display unit for outputting/displaying relevant information to a user in accordance with the illustrated embodiments described herein. The memory 970 preferably stores data that supports various functions of the AI device 900. For example, the memory 970 may store input data acquired by the input unit 920, learning data, a learning model, a learning history, and the like.

The processor 980 preferably determines at least one executable operation of the AI device 900 based on information determined or generated by using a data analysis algorithm or a machine learning algorithm. The processor 980 may control the components of the AI device 900 to execute the determined operation. To this end, the processor 980 may request, search, receive, or utilize data of the learning processor 930 or the memory 970. The processor 980 may control the components of the AI device 900 to execute the predicted operation or the operation determined to be desirable among at least one executable operation. When the connection of an external device is required to perform a determined operation, the processor 980 may generate a control signal for controlling the external device and may transmit the generated control signal to the external device. The processor 980 may acquire intention information for the user input and may determine the user's requirements based on the acquired intention information. The processor 980 may acquire the intention information corresponding to the user input by using at least one of a speech to text (STT) engine for converting speech input into a text string or a natural language processing (NLP) engine for acquiring intention information of a natural language.

At least one of the STT engine or the NLP engine may be configured as an artificial neural network, at least part of which is learned according to the machine learning algorithm. At least one of the STT engine or the NLP engine may be learned by the learning processor 930, may be learned by the learning processor 945 of the AI server 950, or may be learned by their distributed processing. The processor 980 may collect history information including the operation contents of the AI device 900 or the user's feedback on the operation and may store the collected history information in the memory 970 or the learning processor 930 or transmit the collected history information to the external device such as the AI server 950. The collected history information may be used to update the learning model.

The processor 980 may control at least part of the components of AI device 900 so as to drive an application program stored in memory 970. Furthermore, the processor 980 may operate two or more of the components included in the AI device 900 in combination so as to drive the application program.

FIG. 9B illustrates an AI server 950 according to the illustrated embodiments. It is to be appreciated that the AI server 950 may refer to a device that learns an artificial neural network by using a machine learning algorithm or uses a learned artificial neural network. The AI server 950 may include a plurality of servers to perform distributed processing or may be defined as a 5G network. At this time, the AI server 950 may be included as a partial configuration of the AI device 900 and may perform at least part of the AI processing together. The AI server 950 may include a communication unit 962, a memory 964, a learning processor 945, a processor 975, and the like. The communication unit 962 can transmit and receive data to and from an external device such as the AI device 900. The memory 964 may include a model storage unit 966. The model storage unit 966 may store a learning or learned model (or an artificial neural network 968) through the learning processor 945.

The learning processor 945 may learn the artificial neural network 968 by using the learning data. The learning model may be used in a state of being mounted on the AI server 950 of the artificial neural network or may be used in a state of being mounted on an external device such as the AI device 900. The learning model may be implemented in hardware, software, or a combination of hardware and software. If all or part of the learning models are implemented in software, one or more instructions that constitute the learning model may be stored in memory 964. The processor 975 may infer the result value for new input data by using the learning model and may generate a response or a control command based on the inferred result value.

With the above description of an AI server 960 and AI processor 980 being described, one or more components thereof may be utilized by the computer/server 106 of the illustrated embodiments, it is to be understood and appreciated that certain embodiments of the computer/server 106 may utilize one or more of the following AI techniques/processes. For instance, since the determined accuracy of a determined address associated with the received captured data is important (e.g., step 860, FIG. 8), the computer/server 106 may utilize one or more of the following AI modeling techniques: a) for any given location calculated from a set of coordinates and other data, estimate a probability that the location result is accurate; and/or b) for a set of coordinates and other collected data, provide a set of probable locations, each with its own probability score. Additionally, since the location data captured by a label 300 may be imprecise, incomplete, or ‘noisy’, the computer/server 106 will utilize AI modeling techniques to improve the algorithms used for geo-location, which may include for instance: a) does weighting different location data types (e.g. GPS, Wi-Fi) relative to each other result in better predictions; b) does the ordering of data (for example, by Wi-Fi signal strength) affect prediction; and/or c) does using more (or fewer) data points result in better prediction, and if so, under what conditions?

Additionally, in accordance with certain other embodiments, the computer/server 106 will determine/construct AI models that provide additional classification for locations. For example, given a set of characteristics about the location and its environment, the address, and the products registered, the AI models will classify a household as a new mover that is or will be replacing appliances.

With certain illustrated embodiments described above, it is to be appreciated that various non-limiting embodiments described herein may be used separately, combined, or selectively combined for specific applications. Further, some of the various features of the above non-limiting embodiments may be used without the corresponding use of other described features. The foregoing description should therefore be considered as merely illustrative of the principles, teachings and exemplary embodiments of this invention, and not in limitation thereof.

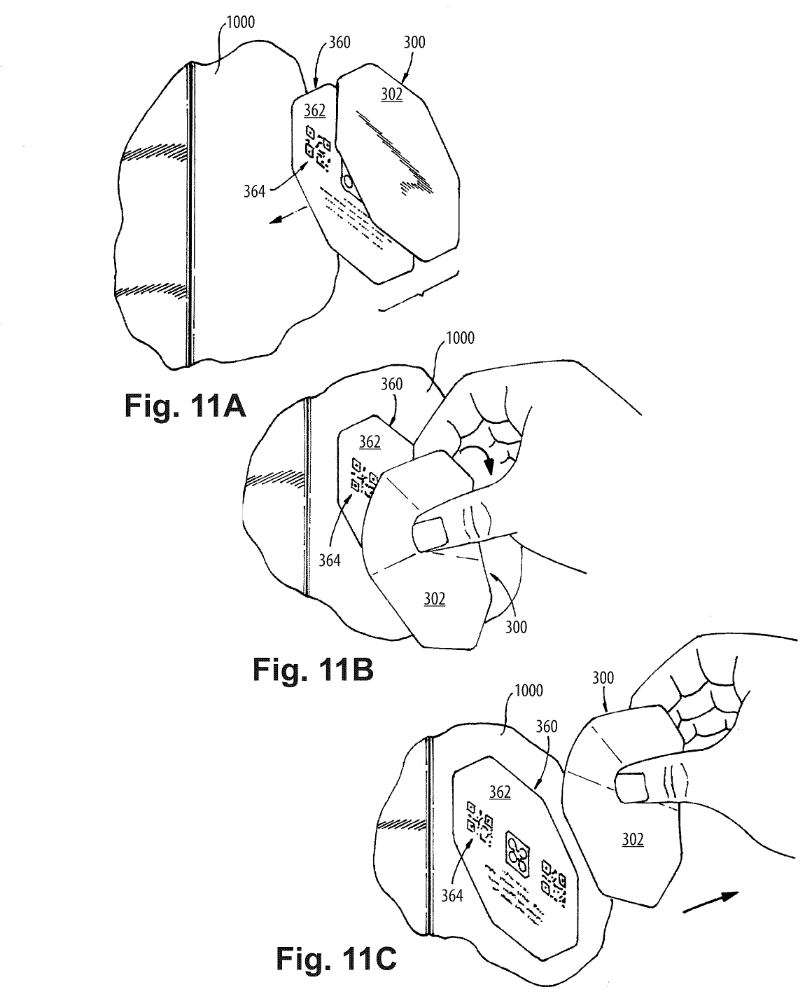

For instance, with reference now to FIGS. 11A-11C, illustrated is another embodiment wherein the electronic label 300 as described above with reference to FIGS. 1-10 is provided with an additional secondary substrate layer 360. For instance, the secondary substrate layer 360 may consist of substrate layer 314, as shown in FIG. 3. The secondary substrate layer 360 is preferably dimensioned to have a substantially similar configuration to that of the primary electronic label 300. The secondary substrate layer 360 has opposing top 362 and bottom surfaces, wherein the top surface 362 of the secondary substrate layer 360 is removably affixed to the bottom surface of the primary electronic label 300 substrate assembly in accordance with the above description for removably adhering the primary electronic label 300 to an article 1000. However, in the illustrated embodiment of FIGS. 11A-11C, the bottom surface of the secondary substrate layer 360 is configured for affixation to the article 1000 (in contrast to removably affixing the bottom surface of the primary electronic label 300 to an article 1000 as described above), which affixation is at least stronger than that of the primary electronic label 300 to the secondary substrate layer 360. For instance, in use, and with reference to FIG. 11B, when the secondary substrate layer 360 of the electronic label 300 is caused to be affixed to an article 1000 (via a suitable adhesive component), when at least a portion of the bottom surface of the primary label 300 is removed from the top surface 362 of the secondary substrate layer 360 that remains affixed to the article (FIG. 11b), the switch assembly 510 of the primary label 300 is then caused to move from a first to a second position (as also described above) so as to couple the battery component 520 to the electronic circuit 500 affecting energization of the electronic circuit 500 of the primary electronic label 300, as described above. The top surface 362 of secondary substrate layer 360 is preferably provided with secondary indicia 364 that is fully exposed to a user of the article 100 when the primary label 300 is caused to be removed from the secondary substrate layer 360, as best shown in FIGS. 11B and 11C. Exposure of this secondary indicia 364 can have many utility purposes, such as providing further instructions/information to a user that remains affixed to the article 1000 (e.g., a washing machine) after the primary label portion 300 was caused to be entirely removed from the article (FIG. 11C).

It is to be understood that the above-described arrangements are only illustrative of the application of the principles of the illustrated embodiments. Numerous modifications and alternative arrangements may be devised by those skilled in the art without departing from the scope of the illustrated embodiments, and the appended claims are intended to cover such modifications and arrangements.

What is claimed is:

1. An electronic label for affixation to an article, comprising:
a substrate assembly adapted to removably affix to the article, the substrate assembly defining opposing planar top and bottom surfaces, the substrate assembly including:
a battery component;
an electronic circuit coupled to the battery component, wherein a unique identifier is associated with the electronic circuit, the electronic circuit including:
a memory; and
a processor disposed in communication with the memory;
a switch assembly having at least a portion provided on the bottom surface of the substrate assembly configured to couple the electronic circuit to the battery component for energizing the electronic circuit responsive to the substrate assembly being at least partially removed relative to the article, such that when energized, the processor upon execution of the instructions is configured to:
capture data associated with a location of the substrate assembly (location information); and
transmit, via a communications network, the captured location data and the unique identifier, to a remotely located computer device for determining an address associated with the location information and identification information associated with the article.

2. The electronic label as recited in claim 1, wherein the substrate assembly is defined by a plurality of layers.

3. The electronic label as recited in claim 1, wherein the planar bottom surface of the substrate assembly defines the switch assembly, wherein at least a portion of the switch assembly is movable from first position to a second responsive to the substrate assembly being at least partially removed relative to the article, such that when at least a portion of the switch assembly is moved to the second position, the electronic circuit is caused to be energized.

4. The electronic label as recited in claim 3, wherein the switch assembly includes a plurality of elongated switch components.

5. The electronic label as recited in claim 4, wherein at least a portion of the planar bottom surface of the substrate assembly is provided with first adhesive material to removably affix the substrate assembly to the article, and at least a portion of each of the plurality of elongated switch components is provided with a second adhesive material to removably affix each of the plurality of elongated switch components to the article, whereby the second adhesive material provides a stronger adhesive bond than the first adhesive material whereby each of the plurality of elongated switch components is movable from the first position to the second position responsive to the substrate assembly being removed relative to the article.

6. The electronic label as recited in claim 1, wherein the electronic label further includes a bottom substrate layer having opposing top and bottom surfaces, wherein the top surface of the bottom substrate layer is removably affixed to the bottom surface of the substrate assembly and the bottom surface of the bottom substrate layer is configured for affixation to the article, whereby when at least a portion of the bottom surface of the substrate assembly is removed from the top surface of the bottom substrate layer, the switch assembly couples the battery component to the electronic circuit affecting energization of the electronic circuit.

7. The electronic label as recited in claim 6, wherein at least a portion of the planar bottom surface of the substrate assembly is provided with first adhesive material to removably affix the substrate assembly to the top surface of the bottom substrate layer, and at least a portion of the switch assembly is provided with a second adhesive material to removably affix the switch assembly to the top surface of the bottom substrate layer, whereby the second adhesive material provides a stronger adhesive bond than the first adhesive material whereby at least a portion of the switch assembly is movable from the first position to the second position responsive to the substrate assembly being at least partially removed from the bottom substrate layer so as to cause energization of the electronic circuit.

8. The electronic label as recited in claim 6, wherein the top surface of substrate assembly is provided with first indicia that is exposed to a user of the article, and wherein the top surface of the bottom substrate layer is provided with second indicia, such that when the substrate assembly is removed from the bottom substrate layer by the user, the second indicia is caused to be exposed to the user.

9. The electronic label as recited in claim 1, wherein capturing data associated with the location of the substrate assembly includes capturing Wi-Fi information relating to a plurality of access points located in proximity to the substrate assembly.

10. The electronic label as recited in claim 9, wherein the captured Wi-Fi information is stored in the memory whereby when the captured location information is transmitted to the remotely located computer device, the stored Wi-Fi information is retrieved from the memory so as to be included in the transmitted captured location data.

11. The electronic label as recited in claim 9, wherein the captured Wi-Fi information includes a mac address and signal strength information associated with a captured access point.

12. The electronic label as recited in claim 9, wherein the processor is further configured to determine if a predetermined threshold amount of Wi-Fi information associated with respective access points have been captured and stored in the memory, whereby if yes, then the captured location information, and the unique identifier, is caused to be transmitted to the remotely located computer device.

13. The electronic label as recited in claim 12, wherein if it is determined a predetermined threshold amount of Wi-Fi information associated with respective access points have not been captured and stored in the memory, then the processor is further configured to initiate a timer for placing the electronic circuit in a sleep mode until expiration of the timer, after which the electronic circuit is re-energized causing the processor to capture additional location information.

14. The electronic label as recited in claim 12, further including a movement sensor coupled to the electronic circuit, and wherein if it is determined a predetermined threshold amount of Wi-Fi information has not been captured, then the processor is further configured for placing the electronic circuit in a sleep mode until the movement sensor detects the substrate assembly has moved a predetermined distance, after which the electronic circuit is re-energized causing the processor to reattempt to send the captured data.

15. The electronic label as recited in claim 1, wherein the processor is further configured to determine if a communications network is accessible for transmitting the captured location data, and the unique identifier to the remotely located computer device, and if no, then the processor is further configured to initiate a timer for placing the electronic circuit in a sleep mode until expiration of the timer, after which the electronic circuit is re-energized causing the processor to again seek access to a communications network for transmitting the captured location data, and the unique identifier, to the remotely located computer device.

16. The electronic label as recited in claim 1, further including a movement sensor coupled to the electronic circuit, wherein the processor is further configured to determine if a communications network is accessible for transmitting the captured location data to the remotely located computer device, and if no, then the processor is further configured for placing the electronic circuit in a sleep mode until the movement sensor detects the substrate assembly has moved, after which the electronic circuit is re-energized causing the processor to again seek access to a communications network for transmitting the captured location data, and the unique identifier, to the remotely located computer device.

17. The electronic label as recited in claim 1, wherein the article consists of one of a: container, an article of manufacture, or living creature.

18. The electronic label as recited in claim 1, wherein the remotely located computer device is configured to determine identity of one or more users associated with the determined address.

19. The electronic label as recited in claim 18, wherein the remotely located computer device utilizes one or more Artificial Intelligence techniques to determine one or more variables associated with the determined user, including propensity to purchase warranty coverage and/or propensity to purchase other products and services.

20. A computer-implemented method for determining a recipient of an article responsive to an electronic label being removed from the article, comprising:
receiving, in a first computer processor, via a communications network, electronic data transmitted from the electronic label responsive to the entirety of the electronic label being separated from the article; and
analyzing, in the first computer processor, the received electronic data transmitted from the electronic label for determining at least identification of the recipient of the article.

21. The computer-implemented method as recited in claim 20, wherein the analyzing step further includes determining an address associated with the recipient.

22. The computer-implemented method as recited in claim 20, wherein the first computer processor is a component of a computer server located in a cloud hosting site.

23. The computer-implemented method as recited in claim 20 wherein the received electronic data consists of location data and a unique identifier associated with the electronic label removed from the article.

24. The computer-implemented method as recited in claim 23, wherein the location data consists of Wi-Fi information relating to a plurality of access points located in proximity to the electronic label removed from the article.

25. The computer-implemented method as recited in claim 20, wherein the first computer processor utilizes one or more Artificial Intelligence techniques to determine one or more variables associated with the determined user, including propensity to purchase warranty coverage and/or propensity to purchase other products and services.

26. The computer-implemented method as recited in claim 20, further including the steps:
determining, by a computer processor provided on the electronic label, whether the electronic label has been removed from the article it was removably affixed to;
capturing, by the computer processor provided on the electronic label, the location data responsive to the entirety of the electronic label being separated from the article;
accessing, by the computer processor provided on the electronic label, a communications network for transmitting the electronic data from the electronic label to the first computer processor responsive to the entirety of the electronic label being separated from the article.

27. The computer-implemented method as recited in claim 26, wherein the capturing step further includes the step of determining, by the computer processor provided on the electronic label, if a predetermined threshold amount of Wi-Fi information associated with respective access points have been captured, whereby if yes, then the electronic data is caused to be transmitted to the first computer processor.

28. The computer-implemented method as recited in claim 27, wherein if it is determined a predetermined threshold amount of Wi-Fi information associated with respective access points has not been captured, the computer processor provided on the electronic label is further configured to initiate a timer for placing the computer processor provided on the electronic label in a sleep mode until expiration of the timer, after which the computer processor provided on the electronic label is re-energized causing the processor to capture additional location information.

29. The electronic label as recited in claim 26, wherein the accessing step further includes the step of determining, by the computer processor provided on the electronic label, if a communications network is accessible for transmitting the electronic data to the first computer processor, and if no, then the computer processor provided on the electronic label initiates a timer for placing the computer processor provided on the electronic label in a sleep mode until expiration of the timer, after which the computer processor provided on the electronic label is re-energized causing it to seek access to a communications network for transmitting the electronic data to the first computer processor.

30. An electronic label for an article, comprising:
a substrate assembly having a plurality of layers adapted to removably affix to the article, the substrate assembly including:
a battery component provided in the substrate assembly;
an electronic circuit provided in the substrate assembly and coupled to the battery component, the electronic circuit including:
a memory; and
a processor disposed in communication with the memory;
a switch assembly provided in the bottom surface of the substrate assembly configured to couple the electronic circuit to the battery component for energizing the electronic circuit responsive to at least a portion of the substrate assembly being removed from the article, such that when energized, the processor upon execution of the instructions is configured to:
capture data associated with a location of the substrate assembly; and
transmit, via a communications network, the captured location data to a remotely located computer device for determining at least identification of a recipient associated with the article.

31. The electronic label as recited in claim 30, when the switch assembly is configured to couple the electronic circuit to the battery component for energizing the electronic circuit responsive to the entirety of substrate assembly being removed from the article.

32. The electronic label as recited in claim 30, wherein the remotely located computer device further determines an address associated with the determined recipient.

33. The electronic label as recited in claim 30, wherein the processor is further configured to determine if a predetermined amount of data associated with a location of the substrate assembly has been captured, whereby if yes, then the captured location information is caused to be transmitted to the remotely located computer device.

34. The electronic label as recited in claim 33, wherein if it is determined a predetermined amount of data associated with a location of the substrate assembly has not been captured, then the processor is further configured to initiate a timer for placing the electronic circuit in a sleep mode until expiration of the timer, after which the electronic circuit is re-energized causing the processor to capture additional data associated with a location of the substrate assembly.

35. The electronic label as recited in claim 30, wherein the processor is further configured to determine if a communications network is accessible for transmitting the captured data associated with a location of the substrate assembly, and if no, then the processor is further configured to initiate a timer for placing the electronic circuit in a sleep mode until expiration of the timer, after which the electronic circuit is re-energized causing the processor to again seek access to a communications network for transmitting the captured data associated with a location of the substrate assembly, to the remotely located computer device.
